(19) United States
(12) Patent Application Publication
(10) Pub. No.: US 2010/0266900 A1
(43) Pub. Date: Oct. 21, 2010

(54) SODIUM-MANGANESE MIXED METAL OXIDE, PRODUCTION METHOD THEREOF AND SODIUM SECONDARY BATTERY

(75) Inventors: Masami Makidera, Tsukuba-shi (JP); Taketsugu Yamamoto, Tsukuba-shi (JP); Satoru Kuze, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY,LIMITED, Chuo-ku,Tokyo (JP)

(21) Appl. No.: 12/743,971

(22) PCT Filed: Nov. 17, 2008
(86) PCT No.: PCT/JP2008/070877

§ 371 Date: May 20, 2010

(30) Foreign Application Priority Data
Nov. 22, 2007 (JP) 2007-303490

(51) Int. Cl. H01M 4/50; H01M 4/88

(52) U.S. Cl. 429/224; 252/182.1

(57) ABSTRACT

Disclosed is a mixed metal oxide which is reduced in the amount of scarce metal used therein, while having excellent performance as a positive electrode active material for secondary batteries. Also disclosed are a positive electrode for sodium secondary batteries having excellent performance, and a sodium secondary battery. Specifically disclosed is a method for producing a sodium-manganese complex metal oxide which is characterized by comprising a step for calcining a material, which contains sodium carbonate (Na₂CO₃) and dimanganese trioxide (Mn₂O₃) in such amounts that the molar ratio of sodium to manganese (Na/Mn) is not less than 0.4 but not more than 0.7, at a temperature of not less than 850° C. Also specifically disclosed are a sodium-manganese complex metal oxide produced by the method, a positive electrode for sodium secondary batteries which contains such a sodium-manganese complex metal oxide, and a sodium secondary battery.

### TECHNICAL FIELD

The present invention relates to a sodium-manganese mixed metal oxide and a production method thereof. More specifically, the present invention relates to a sodium-manganese mixed metal oxide capable of being doped and undoped with sodium ions and usable for a positive electrode active material of a sodium secondary battery, and a production method thereof. The present invention also relates to a sodium secondary battery using the mixed metal oxide for a positive electrode active material.

### BACKGROUND ART

A mixed metal oxide is used for a secondary battery. Among secondary batteries, a lithium secondary battery has already been put into practical use as a small power source for a cellular phone, a notebook computer and the like. Furthermore, a need for a lithium secondary battery as a large power source for electric vehicles, distributed power storages and the like is to be increasing. Therefore, it is necessary to consider changing a material of a lithium secondary battery, in which a generous amount of scarce metals, such as cobalt, nickel and lithium are used. As a less expensive material of the secondary battery, sodium has been considered since it is one digit cheaper than lithium and abundant as a resource. A use of a sodium secondary battery in place of a lithium secondary battery enables mass-production of a large secondary battery for electric vehicles, distributed power storages and the like, without fear of depletion of resources.

Examples of a lithium secondary battery include a secondary battery using a lithium-containing mixed metal oxide for a positive electrode, and a lithium metal or a lithium alloy for a negative electrode; and a secondary battery using a lithium-containing mixed metal oxide for a positive electrode, and a carbonaceous material or the like for a negative electrode. Examples of a sodium secondary battery include a secondary battery using a sodium-containing mixed metal oxide for a positive electrode, and a sodium metal or a sodium alloy for a negative electrode; and a secondary battery using a sodium-containing mixed metal oxide for a positive electrode, and a carbonaceous material or the like for a negative electrode.

Regarding the sodium-containing mixed metal oxide used for the positive electrode of conventional sodium secondary batteries, Patent Document 1 specifically discloses in columns 11 and 12 an orthorhombic sodium-manganese mixed metal oxide of Na_{0.44}MnO₂ obtained by calcining a mixture of raw materials at 800° C. for 12 hours.

Patent Document 1: U.S. Pat. No. 5,558,961

### DISCLOSURE OF THE INVENTION

### Problems to be Solved by the Invention

According to the above-described conventional secondary battery using a sodium-manganese mixed oxide as the positive electrode active material, the used amount of a scarce metal, such as cobalt, nickel and lithium can be reduced as compared with the existing lithium secondary battery. However, there is still room for an improvement with respect to the performance as a secondary battery, for example, a discharge capacity. Accordingly, the present invention provides a sodium-manganese mixed metal oxide having very useful performance as a positive electrode active material in a secondary battery, and a production method thereof. Also, the present invention provides a positive electrode for sodium secondary batteries, and a sodium secondary battery, each using the mixed metal oxide.

### Means to Solve the Problems

As a result of intensive studies to attain the above-described objects, the present inventors have accomplished the present invention. The present invention is as follows.

(1) A method for producing a sodium-manganese mixed metal oxide, comprising a step of calcining a material containing sodium carbonate (Na₂CO₃) and dimanganese trioxide (Mn₂O₃) in amounts which give a sodium-to-manganese molar ratio (Na/Mn) of 0.4 to 0.7, at a temperature of 850° C. or more.

(2) The method as described in (1) above, wherein the calcination is performed at a temperature of 850° C. to 950° C.

(3) The method as described in (1) or (2) above, wherein the calcination is performed over 2 hours to 8 hours.

(4) The method as described in any one of (1) to (3) above, wherein the calcination is performed in an air atmosphere.

(5) A sodium-manganese mixed metal oxide produced by the method as described in any one of (1) to (4) above and having an orthorhombic one-dimensional tunnel structure.

(6) A positive electrode active material for sodium secondary batteries, comprising the mixed metal oxide described in (5) above as a main constituent.

(7) A positive electrode for sodium secondary batteries, containing the positive electrode active material described in (6) above.

(8) A sodium secondary battery, having the positive electrode for sodium secondary batteries described in (7) above.

(9) The sodium secondary battery as described in (8) above, further having a separator.

(10) The sodium secondary battery as described in (9) above, wherein the separator is a separator having a porous laminate film in which a heat-resistant layer containing a heat-resistant resin and a shutdown layer containing a thermoplastic resin are laminated.

As described above, regarding the present invention, a sodium secondary battery includes a secondary battery using a sodium-containing mixed metal oxide for a positive electrode and using a sodium metal or a sodium alloy for a negative electrode; and a secondary battery using a sodium-containing mixed metal oxide for a positive electrode and using a carbonaceous material or the like for a negative electrode. These secondary batteries are collectively referred to as a sodium secondary battery, regarding the present invention.

### BRIEF DESCRIPTION OF THE DRAWINGS

FIG. 1 is a chart showing a result of a powder X-ray diffraction measurement in Example 1.

FIG. 2 is a graph showing discharge curves for the first to third cycles in Example 1, where respective discharge curves for the first to third cycles are overlapped.

FIG. 3 is a graph showing discharge curves for the first to third cycles in Comparative Example 1, where respective discharge curves for the first to third cycles are overlapped.

### BEST MODE FOR CARRYING OUT THE INVENTION

The present invention is described in detail below.

### <Production Method of Sodium-Manganese Mixed Metal Oxide of the Present Invention>

The method of the present invention for producing a sodium-manganese mixed metal oxide is characterized by comprising a step of calcining a material containing sodium carbonate (Na₂CO₃) and dimanganese trioxide (Mn₂O₃) in amounts which give a sodium-to-manganese molar ratio (Na/Mn) of 0.4 to 0.7, at a temperature of 850° C. or more.

In the method of the present invention for producing a sodium-manganese mixed metal oxide, the sodium-to-manganese molar ratio (Na/Mn) is preferably from 0.4 to 0.7, more preferably from 0.4 to 0.6, so as to obtain an orthorhombic one-dimensional tunnel structure. More specifically, the ratio (Na/Mn) is preferably 0.4 or more because of preventing generation of a manganese oxide having a hollandite-type tunnel structure, and the ratio (Na/Mn) is preferably 0.7 or less because of preventing generation of a manganese oxide having a diblock-type tunnel structure.

According to the method of the present invention, a sodium-manganese mixed metal oxide <exhibiting a remarkable performance> can be obtained when it is used as a positive electrode active material for sodium secondary batteries. Although not wishing to be bound by any theories, it is guessed that the oxidation state of manganese during a reaction process can be appropriately controlled by calcining a material containing sodium carbonate (Na₂CO₃) and dimanganese trioxide (Mn₂O₃) in an appropriate ratio, at a specific temperature of 850° C. or more.

In the method of the present invention for producing a sodium-manganese mixed metal oxide, a raw material containing sodium carbonate and dimanganese trioxide, particularly a raw material containing only sodium carbonate and dimanganese trioxide, is used as a source containing sodium and manganese. A flux such as a boron compound (e.g., boric acid) may also be used in combination with sodium carbonate and dimanganese trioxide. For mixing for producing these raw materials, an apparatus usually employed in industry, such as V-type mixer, W-type mixer, ribbon mixer, drum mixer and ball mill, can be used. The mixing thereof may be performed by either a dry mixing or a wet mixing, and, in particular, the mixing can be performed by dry mixing.

In the method of the present invention for producing a sodium-manganese mixed metal oxide, the calcination is preferably performed at a temperature of 850° C. or more, particularly at a temperature of 850° C. to 950° C. The calcination can be performed at the temperature, for example, over 2 hours to 8 hours, preferably over 4 hours to 8 hours. Furthermore, the calcination can be performed in an oxidizing atmosphere, for example, in air. During the calcination, it is sometimes preferred to reach the above-described calcination temperature rapidly <<within the range not damaging the calcination vessel in which the mixture is placed>>, for example, at a temperature rise rate of 5° C./rain or more.

In the case of using the sodium-manganese mixed metal oxide obtained by the method of the present invention as a positive electrode active material for sodium secondary batteries, it is sometimes preferred to adjust a particle size of the sodium-manganese mixed metal oxide of the present invention by optionally subjecting the sodium-manganese metal oxide to pulverization by means of a ball mill, a jet mill or the like, washing, classification, or the like. The calcination may be performed two or more times. The particle of the mixed metal oxide may be surface-treated, for example, by coating the surface with an inorganic substance containing Si, Al, Ti, Y or the like.

### <Sodium-Manganese Mixed Metal Oxide of the Present Invention>

The sodium-manganese mixed metal oxide of the present invention is produced by the method of the present invention for producing a sodium-manganese mixed metal oxide and has an orthorhombic one-dimensional tunnel structure.

When the sodium-manganese mixed metal oxide of the present invention is used as a positive electrode active material for sodium secondary batteries by itself or after, for example, coating it with an inorganic substance, a secondary battery having excellent performance, particularly a large discharge capacity, can be provided. That is, the positive electrode active material for sodium secondary batteries using the sodium-manganese mixed metal oxide of the present invention as a main constituent can be suitably used for sodium secondary batteries. Also, the sodium-manganese mixed metal oxide of the present invention mainly uses sodium and manganese which are abundant as resources, and therefore can be produced at lower cost.

### <Positive Electrode for Sodium Secondary Batteries of the Present Invention and Production Method Thereof>

A positive electrode for sodium secondary batteries of the present invention contains the positive electrode active material of the present invention. The positive electrode for sodium secondary batteries of the present invention can be produced by loading, on a positive electrode current collector, a positive electrode mixture containing the mixed metal oxide of the present invention, an electrically conductive material and a binder.

Examples of the electrically conductive material include a carbonaceous material, such as natural graphite, artificial graphite, coke, and carbon black. Examples of the binder include a thermoplastic resin, and specific examples thereof include a fluororesin, such as polyvinylidene fluoride (hereinafter referred to as “PVDF”), polytetrafluoroethylene, ethylene tetrafluoride-propylene hexafluoride-vinylidene fluoride-based copolymer, propylene hexafluoride-vinylidene fluoride-based copolymer, and ethylene tetrafluoride-perfluorovinyl ether-based copolymer; and a polyolefin resin, such as polyethylene and polypropylene. Examples of the positive electrode current collector which can be used include Al, Ni and stainless steel.

A method for loading a positive electrode mixture on a positive electrode current collector includes a method of pressure-molding the mixture, and a method of forming the positive electrode mixture into a paste by using an organic solvent or the like, coating and drying the paste on a positive electrode current collector, and fixing the coating by pressing. In the case of forming a paste, a slurry comprising a positive electrode active material, an electrically conductive material, a binder and an organic solvent is prepared. Examples of the organic solvent include an amine-based solvent, such as N,N-dimethylaminopropylamine and diethyltriamine; an ether-based solvent, such as ethylene oxide and tetrahydrofuran; a ketone-based solvent, such as methyl ethyl ketone; an ester-based solvent, such as methyl acetate; and an aprotic polar solvent, such as dimethylacetamide and N-methyl-2-pyrrolidone. Examples of the method for coating a positive electrode mixture on a positive electrode current collector include a slit die coating method, a screen coating method, a curtain coating method, a knife coating method, a gravure coating method, and an electrostatic spraying method.

### <Sodium Secondary Battery of the Present Invention>

A sodium secondary battery of the present invention has the positive electrode for sodium secondary batteries of the present invention. The sodium secondary battery of the present invention can be produced by stacking a separator, a negative electrode comprising a negative electrode current collector having loaded thereon a negative electrode mixture, and the positive electrode for sodium secondary batteries of the present invention, winding the stack to obtain an electrode group, housing the electrode group in a battery can, and impregnating the electrode group with an electrolytic solution composed of an organic solvent containing an electrolyte.

Examples of the shape of the electrode group include a shape that gives a cross section of a circular shape, an elliptical shape, a rectangular shape, a corner-rounded rectangular shape or the like, when the electrode group is cut in the direction perpendicular to the winding axis. Examples of the shape of the battery include a paper shape, a coin shape, a cylinder shape, and a square shape.

### <Sodium Secondary Battery of the Present Invention/Negative Electrode>

A negative electrodes usable in the sodium secondary battery of the present invention include sodium metal, a sodium alloy, and a negative electrode obtained by loading, on a negative electrode current collector, a negative electrode mixture containing a material capable of being intercalated and deintercalated with sodium ions. The material capable of being intercalated and deintercalated with sodium ions includes a carbonaceous material, such as natural graphite, artificial graphite, coke, carbon black, pyrolytic carbons, carbon fiber and calcined organic polymer compound. The shape of the carbonaceous material may be any of a flake, such as natural graphite, a sphere, such as mesocarbon microbead, a fiber, such as graphitized carbon fiber, or an aggregate of fine powder.

As the material capable of being intercalated and deintercalated with sodium ions, a chalcogen compound, such as oxide and sulfide, capable of being intercalated and deintercalated with sodium ions at a lower potential than a positive electrode may also be used.

The negative electrode mixture may contain a binder, if necessary. Accordingly, the negative electrode of the sodium secondary battery of the present invention may be configured to contain a mixture of a carbonaceous material and a binder. The binder includes a thermoplastic resin, and specific examples thereof include PVDF, thermoplastic polyimide, carboxymethyl cellulose, polyethylene and polypropylene.

Examples of the negative electrode current collector include Cu, Ni and stainless steel, and Cu is preferred because Cu is difficult to be an alloy with lithium or sodium, and is easily formed into a thin film. Examples of the method for loading a negative electrode mixture on a negative electrode current collector are the same as in the case of a positive electrode and include a method of pressure-molding the mixture, and a method of forming the negative electrode mixture into a paste by using a solvent or the like, coating and drying the paste on a negative electrode current collector, and fixing the coating by pressing.

### <Sodium Secondary Battery of the Present Invention/Separator>

As a separator usable in the sodium secondary battery of the present invention, a member having a form, such as porous film, nonwoven fabric and woven fabric and made of a material of a polyolefin resin, such as polyethylene and polypropylene, a fluororesin or a nitrogen-containing aromatic polymer can be used. A single-layer or multilayer separator using two or more of these materials may also be used. Examples of the separator include separators described in Japanese Unexamined Patent Publication Nos. 2000-30686 and 10-324758. A thickness of the separator is preferably smaller as long as the mechanical strength can be maintained, from the standpoint of increase in the volumetric energy density of a battery and decrease in internal resistance thereof. In general, a thickness of the separator is preferably about 5 to 200 μm, more preferably about 5 to 40 μm.

In a secondary battery, usually, when an extraordinary current flows in the battery due to short-circuit between a positive electrode and a negative electrode, or the like, the current is preferably blocked to prevent an overcurrent from flowing (to shutdown). Accordingly, the separator preferably activates a shutdown (clogs fine pores of the porous film) at as a low temperature as possible in case of exceeding a usual use temperature. Further, even when the temperature in the battery rises to a certain high temperature after the shutdown, it is preferable that the separator maintain the shutdown state without being ruptured due to the temperature, in other words, have high heat resistance. The secondary battery of the present invention can be more successfully prevented from thermal film rupture by using, as the separator, a separator having a porous laminate film in which a heat-resistant layer containing a heat-resistant resin and a shutdown layer containing a thermoplastic resin are laminated.

### <Sodium Secondary Battery of the Present Invention/Separator/Porous Laminate Film Separator>

The separator composed of a porous laminate film obtained by laminating a heat-resistant layer containing a heat-resistant resin and a shutdown layer containing a thermoplastic resin is described below. The thickness of the separator is usually 40 μm or less, preferably 20 μm or less. Assuming that the thickness of the heat-resistant layer is A (μm) and the thickness of the shutdown layer is B (μm), the value of A/B is preferably from 0.1 to 1. Considering the ion permeability, the permeability of the separator is, in terms of Gurley permeability, preferably from 50 to 300 seconds/100 ml, more preferably from 50 to 200 seconds/100 ml. The void content of the separator is usually from 30 to 80 vol %, preferably from 40 to 70 vol %.

### (Heat-Resistant Layer)

In the porous laminate film, the heat-resistant layer contains a heat-resistant resin. In order to elevate the ion permeability, the thickness of the heat-resistant layer is preferably from 1 to 10 μm, more preferably from 1 to 5 μm, and particularly preferably from 1 to 4 μm to be a thinner heat resistant layer. The heat-resistant layer has fine pores, and the size (diameter) of the pore is usually 3 μm or less, preferably 1 μm or less. The heat-resistant layer may contain a filler described later.

The heat-resistant resin contained in the heat-resistant layer includes polyamide, polyimide, polyamideimide, polycarbonate, polyacetal, polysulfone, polyphenylene sulfide, polyether ketone, aromatic polyester, polyethersulfone and polyetherimide. From the standpoint of further enhancing the heat resistance, polyamide, polyimide, polyamideimide, polyethersulfone and polyetherimide are preferred; and polyamide, polyimide and polyamideimide are more preferred. The heat-resistant resin is more preferably a nitrogen-containing aromatic polymer, such as aromatic polyamide (para-oriented aromatic polyamide, meta-oriented aromatic polyamide), aromatic polyimide and aromatic polyamideimide, still more preferably an aromatic polyamide, and in view of production, yet still more preferably a para-oriented aromatic polyamide (hereinafter, referred to as “para-aramide”). In addition, the heat-resistant resin also includes poly-4-methylpentene-1, and a cyclic olefin-based polymer. By using such a heat-resistant resin, the heat resistance can be enhanced, i.e. the thermal film rupture temperature can be raised.

The thermal film rupture temperature depends on the types of heat-resistant resin, but the thermal film rupture temperature is usually 160° C. or more. By using the above-described nitrogen-containing aromatic polymer as the heat-resistant resin, the thermal film rupture temperature can be raised up to about 400° C. The thermal film rupture temperature can be raised up to about 250° C. by using poly-4-methylpentene-1, and up to about 300° C. by using a cyclic olefin-based polymer.

The para-aramide is obtained by condensation polymerization of a para-oriented aromatic diamine and a para-oriented aromatic dicarboxylic acid halide, and is substantially composed of a repeating unit where the amide bond is bonded at the para-position or equivalently oriented position (for example, the oriented position extending coaxially or in parallel to the opposite direction, such as 4,4′-biphenylene, 1,5-naphthalene, and 2,6-naphthalene) of the aromatic ring. The para-aramide includes a para-aramide having a para-oriented-type and quasi-para-oriented-type structures. Specific examples thereof include poly(paraphenyleneterephthalamide), poly(parabenzamide), poly(4,4′-benzanilideterephthalamide), poly(paraphenylene-4,4′-biphenylenedicarboxylic acid amide), poly(paraphenylene-2,6-naphthalenedicarboxylic acid amide), poly(2-chloro-paraphenyleneterephthalamide) and a paraphenyleneterephthalamide/2,6-dichloroparaphenyleneterephthalamide copolymer.

The aromatic polyimide is preferably a wholly aromatic polyimide produced by condensation polymerization of an aromatic diacid anhydride and a diamine. Specific examples of the diacid anhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Examples of the diamine include oxydianiline, para-phenylenediamine, benzophenonediamine, 3,3′-methylenedianiline, 3,3′-diaminobenzophenone, 3,3′-diaminodiphenylsulfone, and 1,5′-naphthalenediamine. A polyimide soluble in a solvent may be suitably used. Examples of such a polyimide include a polyimide as a polycondensate of 3,3′,4,4′-diphenylsulfonetetracarboxylic dianhydride with an aromatic diamine.

Examples of the aromatic polyamideimide include those obtained by condensation polymerization of an aromatic dicarboxylic acid and an aromatic diisocyanate, and those obtained by condensation polymerization of an aromatic diacid anhydride and an aromatic diisocyanate. Specific examples of the aromatic dicarboxylic acid include isophthalic acid and terephthalic acid. Specific examples of the aromatic diacid anhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylene diisocyanate and m-xylylene diisocyanate.

The filler that may be contained in the heat-resistant layer may be any one selected from an organic powder, an inorganic powder and a mixture thereof. The average particle diameter of the particle constituting the filler is preferably from 0.01 to 1 μm or less. Examples of the shape of the filler include an approximately spherical shape, a plate shape, a columnar shape, an acicular particle, a whisker shape and a fibrous shape, and any particles of these shapes may be used. The filler is preferably an approximately spherical particle due to ease in forming uniform pores.

The organic powder as the filler includes a powder composed of an organic material, such as a homopolymer of or a copolymer of two or more kinds of styrene, vinyl ketone, acrylonitrile, methyl methacrylate, ethyl methacrylate, glycidyl methacrylate, glycidyl acrylate and methyl acrylate; a fluororesin, such as polytetrafluoroethylene, tetrafluoroethylene-hexafluoropropylene copolymer, tetrafluoroethylene-ethylene copolymer and polyvinylidene fluoride; a melamine resin; a urea resin; a polyolefin; and polymethacrylate. The organic powders may be used singly, or in admixture of two or more. Among the organic powders, a polytetrafluoroethylene powder is preferred in view of chemical stability.

Examples of the inorganic powder as the filler include a powder composed of an inorganic material, such as metal oxide, metal nitride, metal carbide, metal hydroxide, carbonate and sulfate. Specific examples thereof include a powder composed of alumina, silica, titanium dioxide or calcium carbonate. The inorganic powders may be used singly, or in admixture of two or more. Among the inorganic powders, an alumina powder is preferred in view of chemical stability. It is preferred that all of the particles constituting the filler be an alumina particle, and more preferred that all of the particles constituting the filler be an alumina particle, and a part or all thereof are an approximately spherical alumina particle.

The content of the filler in the heat-resistant layer varies depending on the specific gravity of the material used for the filler. For example, in the case where all of the particles constituting the filler are an alumina particle, the weight of the filler is usually from 20 to 95 parts by weight, preferably from 30 to 90 parts by weight, assuming that the total weight of the heat-resistant layer is 100 parts by weight. This range can be appropriately set, depending on the specific gravity of the material used for the filler.

### (Shutdown Layer)

In the porous laminate film, the shutdown layer contains a thermoplastic resin. The thickness of the shutdown layer is usually from 3 to 30 preferably from 3 to 20 μm. The shutdown layer has fine pores similarly to the heat-resistant layer, and the size of the pore is usually 3 μm or less, preferably 1 μm or less. The void content of the shutdown layer is usually from 30 to 80 vol %, preferably from 40 to 70 vol %. When a temperature of nonaqueous electrolyte secondary battery exceeds a usual use temperature, the shutdown layer plays a roll of clogging the fine pores due to softening of the thermoplastic resin constituting the shutdown layer.

The thermoplastic resin contained in the shutdown layer includes a resin that is softened at 80 to 180° C., and a thermoplastic resin which does not dissolve in the electrolytic solution of a nonaqueous electrolyte secondary battery may be selected. Specific examples of the thermoplastic resin include a polyolefin, such as polyethylene and polypropylene, and a thermoplastic polyurethane. A mixture of two or more of these resins may be used. In order to activate a shutdown by softening at a lower temperature, the thermoplastic resin is preferably polyethylene. The polyethylene specifically includes a polyethylene, such as low-density polyethylene, high-density polyethylene and linear polyethylene, and also includes an ultrahigh molecular-weight polyethylene. For further enhancing the piercing strength of the shutdown layer, the thermoplastic resin preferably contains at least an ultrahigh molecular-weight polyethylene. In view of production of the shutdown layer, it is sometimes preferred that the thermoplastic resin contains a wax composed of a polyolefin of low molecular-weight (weight average molecular weight of 10,000 or less).

### <Sodium Secondary Battery of the Present Invention/Electrolytic Solution or Solid Electrolyte>

The examples of the electrolytic solution usable in the sodium secondary battery of the present invention include NaClO₄, NaPF₆, NaAsF₆, NaSbF₆, NaBF₄, NaCF₃SO₃, NaN(SO₂CF₃)₂, sodium salt of lower aliphatic carboxylate, and NaAlCl₄. A mixture of two or more thereof may be used. Among these, an electrolyte containing fluorine, which contains at least one member selected from the group consisting of NaPF₆, NaAsF₆, NaSbF₆, NaBF₄, NaCF₃SO₃ and NaN(SO₂CF₃)₂, is preferably used.

In the electrolytic solution usable in the sodium secondary battery of the present invention, examples of the organic solvent, which can be used include carbonates, such as propylene carbonate (PC), ethylene carbonate, dimethyl carbonate, diethyl carbonate, ethyl methyl carbonate, isopropyl methyl carbonate, vinylene carbonate, 4-trifluoromethyl-1,3-dioxolan-2-one and 1,2-di(methoxycarbonyloxy)ethane; ethers, such as 1,2-dimethoxyethane, 1,3-dimethoxypropane, pentafluoropropylmethyl ether, 2,2,3,3-tetrafluoropropyldifluoromethyl ether, tetrahydrofuran and 2-methyltetrahydrofuran; esters, such as methyl formate, methyl acetate and γ-butyrolactone; nitrites, such as acetonitrile and butyronitrile; amides, such as N,N-dimethylformamide and N,N-dimethylacetamide; carbamates, such as 3-methyl-2-oxazolidone; sulfur-containing compounds, such as sulfolane, dimethyl sulfoxide and 1,3-propanesultone; and those obtained by introducing a fluorine substituent into the organic solvent above. Usually, two or more of the organic solvents are mixed and used.

A solid electrolyte may also be used in place of the electrolytic solution. Examples of the solid electrolyte which can be used include an organic polymer electrolyte, such as polyethylene oxide-based polymer, and polymer containing at least one or more of polyorganosiloxane chains or polyoxyalkylene chains. A so-called gel-type electrolyte holding a nonaqueous electrolyte solution in a polymer can also be used. An inorganic solid electrolyte, such as sulfide electrolyte (e.g., Na₂S—SiS₂, Na₂S—GeS₂) and NASCON-type electrolyte (e.g., NaZr₂(PO₄)₃) may also be used. When such a solid electrolyte is used, safety can be enhanced in some cases. In the case of using a solid electrolyte in the sodium secondary battery of the present invention, the solid electrolyte sometimes works as the separator and in this case, a separator may not be necessary.

### EXAMPLES

The present invention is described in greater detail below by referring to examples, but the present invention is not limited thereto by any means. Incidentally, unless otherwise indicated, a production method of an electrode and a test battery for a charge/discharge test, and a measurement method of powder X-ray diffraction are as follows.

### (1) Production of Electrode (Positive Electrode)

A mixed metal oxide as a positive electrode active material, an acetylene black (produced by Denki Kagaku Kogyo Kabushiki Kaisha) as an electrically conductive material, and PVDF (PolyVinylidine DiFluoride Polyflon, produced by Kureha Corporation) as a binder were weighed to obtain a composition of positive electrode active material:electrically conductive material:binder=85:10:5 (by weight). Thereafter, the mixed metal oxide and acetylene black were thoroughly mixed in an agate mortar, an appropriate amount of N-methyl-2-pyrrolidone (NMP, produced by Tokyo Chemical Industry Co., Ltd.) was added to the mixture, PVDF was further added, and these were then uniformly mixed to form a slurry. The obtained slurry was coated on a 40 μm-thick aluminum foil as a current collector by using an applicator to a thickness of 100 μm, and the aluminum foil having the coated slurry was placed in a drier and thoroughly dried by removing NMP to obtain an electrode sheet. This electrode sheet was punched with a diameter of 1.5 cm by an electrode punch, and sufficiently fixed under pressure by a hand press to obtain a positive electrode sheet.

### (2) Production of Test Battery

The positive electrode sheet was placed in a recess of the bottom part of a coin cell (manufactured by Hohsen Corp.) by arranging the aluminum foil to face downward and combined with a 1 M NaClO₄/PC (propylene carbonate) as an electrolyte, a polypropylene porous film (thickness: 20 μm) as a separator, and a sodium metal (produced by Aldrich Chemical Company, Inc.) as a negative electrode to produce a test battery. Assembly of the test battery was performed in a glove box under an argon atmosphere.

### (3) Powder X-Ray Diffraction Measurement

The measurement was performed under the following conditions by using a powder X-ray diffraction measuring apparatus, Model RINT2500TTR, manufactured by Rigaku Corporation.

X-ray: CuKα

Voltage-current: 40 kV-140 mA

Measuring angle range: 2θ=10-90°

Step: 0.02°

Scan speed: 4°/min

### Example 1

### Na_{0.5}MnO₂

### (1) Synthesis of Sodium-Manganese Mixed Metal Oxide

Sodium Carbonate (Na₂CO₃) and Dimanganese Trioxide (Mn₂O₃) were weighed into amounts giving a sodium-to-manganese molar ratio (Na/Mn) of 0.5, and mixed in an agate mortar. The obtained mixture was calcined by keeping it in an air atmosphere at 900° C. over 6 hours, and again pulverized in an agate mortar to obtain the sodium-manganese mixed metal oxide of this Example.

### (2) Powder X-Ray Diffraction Measurement

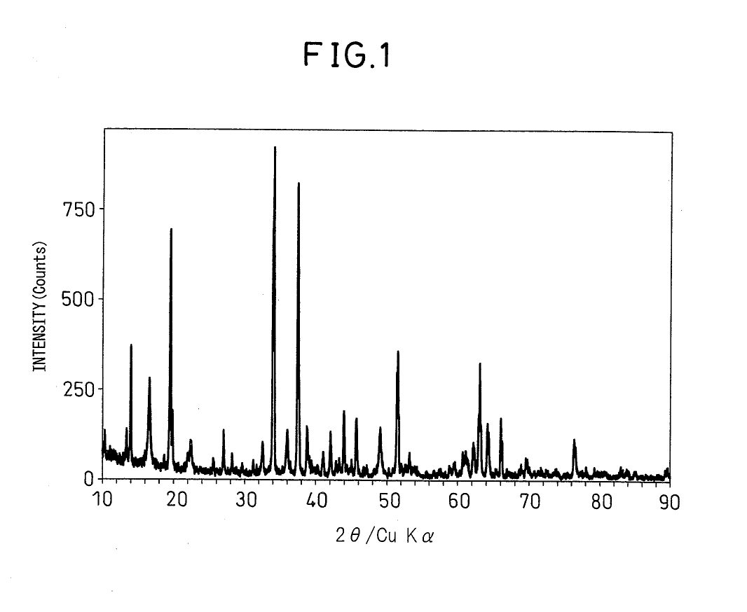

FIG. 1 shows the result of the powder X-ray diffraction measurement of the sodium-manganese mixed metal oxide of Example 1. According to FIG. 1, it was confirmed that the sodium-manganese mixed metal oxide of Example 1 had an orthorhombic one-dimensional Tunnel structure as its crystal structure. Also, according to FIG. 1, the peak intensity ratio of (130)/(201) was 0.4022.

### (3) Evaluation of Charge/Discharge Performance as Positive Electrode Active Material for Sodium Secondary Battery

A test battery was produced by using the mixed metal oxide of Example 1 as a positive electrode active material for sodium secondary batteries, and subjected to a constant current charge/discharge test under the following conditions.

### Charge/Discharge Conditions:

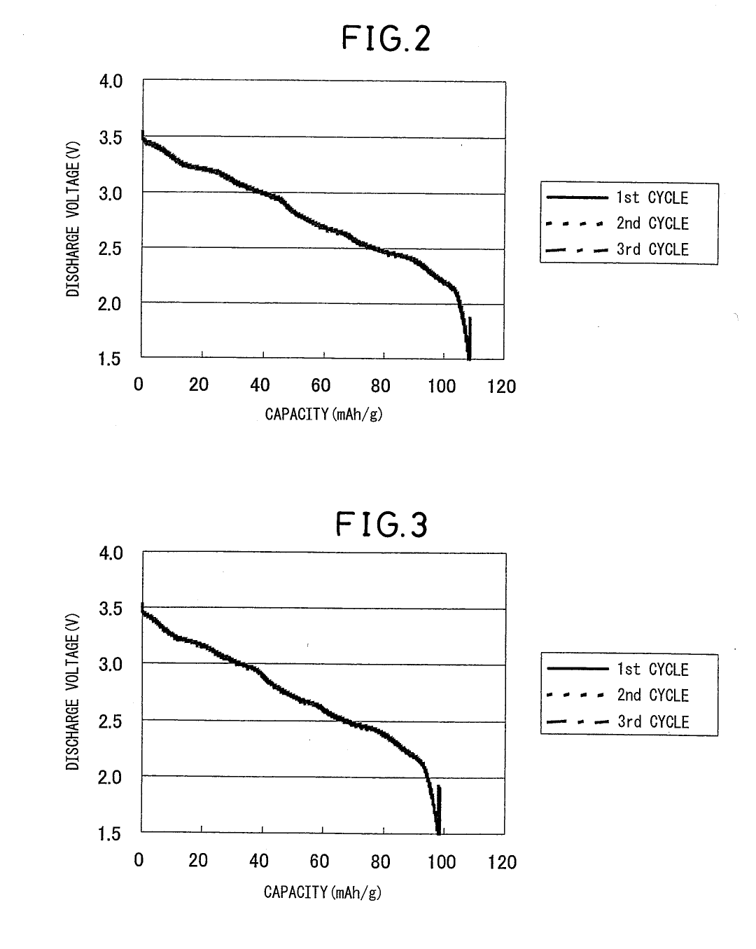

The charge was performed at the CC (constant current) charge of 0.1 C (rate that requires 10 hours for full charge) from rest potential to 3.8 V. The discharge was performed at the CC (constant current) discharge of 0.1 C (rate that requires 10 hours for complete discharge), and the current was cut off at a voltage of 1.5 V. FIG. 2 shows the results obtained. As shown in FIG. 2, the discharge capacity for the first to third cycles of this charge/discharge cycle was as high as 109 mAh/g and, at the same time, constant.

### Comparative Example 1

### Na_{0.5}MnO₂

### (1) Synthesis of Sodium-Manganese Mixed Metal Oxide

The sodium-manganese mixed metal oxide of Comparative Example was obtained in the same manner as in Example 1, except for calcining the mixture by keeping it at 800° C.

### (2) Powder X-Ray Diffraction Analysis

From the result of the powder X-ray diffraction measurement of the sodium-manganese mixed metal oxide of Comparative Example 1, it was confirmed that the mixed metal oxide of Comparative Example 1 had an orthorhombic crystal structure.

### (3) Evaluation of Charge/Discharge Performance as Positive Electrode Active Material for Sodium Secondary Battery

A test battery was produced by using the sodium-manganese mixed metal oxide of Comparative Example 1, and subjected to a constant current charge/discharge test, in the same manner as in Example 1. FIG. 3 shows the results obtained. As shown in FIG. 3, the discharge capacity for the first to third cycles was constant, but as low as 97 mAh/g.

### Production Example 1

### Production of Porous Laminate Film

### (1) Production of Coating Solution for Heat-Resistant Layer

After dissolving 272.7 g of calcium chloride in 4,200 g of N-methyl-2-pyrrolidone (NMP), 132.9 g of para-phenylenediamine was added and completely dissolved. To the obtained solution, 243.3 g of terephthalic acid dichloride was gradually added to effect the polymerization, and thereby obtain a para-aramide. The obtained solution was further diluted with NMP to obtain a para-aramide solution having a concentration of 2.0 wt %. To 100 g of the obtained para-aramide solution, 2 g of a first alumina powder (Alumina C, produced by Nippon Aerosil Co., Ltd., average particle diameter: 0.02 μm) and 2 g of a second alumina powder (Sumicorundum AA03, produced by Sumitomo Chemical Co., Ltd., average particle diameter: 0.3 μm), as a filler in total of 4 g, were added and mixed. The resulting mixture was subjected to a nanomizer three times, filtered with a 1,000-mesh metal screen, and defoamed under reduced pressure to produce a slurried coating solution for heat-resistant layer. The amount of the alumina powder (filler) was 67 wt %, based on the total weight of the para-aramide and alumina powder.

### (2) Production of Porous Laminate Film

As the shutdown layer, a polyethylene porous film (film thickness of 12 μm, air permeability of 140 seconds/100 ml, average pore diameter of 0.1 μm, void content of 50%) was used. The polyethylene porous film above was fixed on a 100 μm-thick PET film, and the slurried coating solution for heat-resistant layer was coated on the porous film by a bar coater manufactured by Tester Sangyo Co, Ltd. The coated porous film on the PET film was, while maintaining the integrity, dipped in water, which is a poor solvent, to precipitate a para-aramide porous film (heat-resistant layer). After that, the solvent was dried to obtain a porous laminate film comprising a heat-resistant layer and a shutdown layer laminated thereon.

### (3) Evaluation of Porous Laminate Film

The thickness of the porous laminate film was 16 μm, and the thickness of the para-aramide porous film (heat-resistant layer) was 4 μm. The air permeability of the porous laminate film was 180 seconds/100 ml, and the void content was 50%. The cross-section of the heat-resistant layer in the porous laminate film was observed by a scanning electron microscope (SEM), as a result, the heat-resistant layer was found to have relatively small pores of approximately 0.03 to 0.06 μm and relatively large pores of approximately 0.1 to 1 μm.

Evaluations of the porous laminate film were performed as in the following (A) to (C).

### (A) Thickness Measurement

The thicknesses of the porous laminate film and the shutdown layer were measured in accordance with JIS standards (K7130-1992). The thickness of the heat-resistant layer was calculated by subtracting the thickness of the shutdown layer from the thickness of the porous laminate film.

### (B) Measurement of Air Permeability by Gurley Method

The air permeability of the porous laminate film was measured based on JIS P8117 by a digital-timer type Gurley densometer manufactured by Yasuda Seiki Seisakusho, Ltd.

### (C) Void Content

The obtained porous laminate film sample was cut into a square shape which is 10 cm on each side, and the weight W (g) and the thickness D (cm) were measured. The weight (Wi) of each layer in the sample was determined, the volume of each layer was determined from Wi and the true specific gravity (g/cm³) of each layer, and the void content (vol %) was determined according to the following formula:

Void content(vol %)=100×{1−(W1/true specific gravity 1+W2/true specific gravity 2++Wn/true specific gravity n)/(10×10×D)}

When the porous laminate film obtained herein is used as the separator in the sodium secondary batteries of the above Examples, the sodium secondary batteries can more successfully prevent thermal film rupture.

1. A method for producing a sodium-manganese mixed metal oxide, comprising a step of calcining a material containing sodium carbonate (Na2CO3) and dimanganese trioxide (Mn₂O₃) in amounts which give a sodium-to-manganese molar ratio (Na/Mn) of 0.4 to 0.7, at a temperature of 850° C. or more.

2. The method according to claim 1, wherein the calcination is performed at a temperature of 850° C. to 950° C.

3. The method according to claim 1, wherein the calcination is performed over 2 hours to 8 hours.

4. The method according to claim 1, wherein the calcination is performed in an air atmosphere.

5. A sodium-manganese mixed metal oxide produced by the method according to claim 1 and having an orthorhombic one-dimensional tunnel structure.

6. A positive electrode active material for sodium secondary batteries, comprising the mixed metal oxide according to claim 5 as a main constituent.

7. positive electrode for sodium secondary batteries, containing the positive electrode active material according to claim 6.

8. A sodium secondary battery, having the positive electrode for sodium secondary batteries according to claim 7.

9. The sodium secondary battery according to claim 8, further having a separator.

10. The sodium secondary battery according to claim 9, wherein the separator is a separator having a porous laminate film in which a heat-resistant layer containing a heat-resistant resin and a shutdown layer containing a thermoplastic resin are laminated.
